(19) United States
(12) Patent Application Publication
(10) Pub. No.: US 2025/0262699 A1
(43) Pub. Date: Aug. 21, 2025

(54) TOOL PRESETTING AND/OR TOOL MEASURING SYSTEM, TOOL PRESETTING AND/OR TOOL MEASURING METHOD, COMPUTER PROGRAM PRODUCT AND CONTROL AND/OR REGULATION UNIT

(71) Applicant: E. ZOLLER GmbH & Co. KG Einstell-und Messgeraete, Pleidelsheim (DE)

(72) Inventors: Christian PFAU, Ingersheim (DE); Ali M. MANSOORY K., Pleidelsheim (DE)

(21) Appl. No.: 19/045,976

(22) Filed: Feb. 5, 2025

(30) Foreign Application Priority Data
Feb. 21, 2024 (DE) 10 2024 104 907.3

(51) Int. Cl. B23Q 3/155; G06T 7/246; G06T 7/73; G06V 10/82; G06V 20/52; G06V 20/60

(52) U.S. Cl. CPC B23Q 3/15503; G06T 7/248; G06T 7/74; G06V 10/82; G06V 20/52; G06V 20/60; G06T 2207/20081; G06T 2207/20084; G06T 2207/30204; G06V 2201/06

(57) ABSTRACT

A tool-presetting and/or tool-measuring system has an optical tool-presetting and/or tool-measuring apparatus, has at least one camera which is at least configured to capture camera images of a tool-presetting and/or tool-measuring region of the tool-presetting and/or tool-measuring apparatus and/or of a tool-storage, tool-retrieval or tool-intermediate-storage region of the tool-presetting and/or tool-measuring system, and has an, in particular external or internal, control and/or regulation unit which is at least configured to store and evaluate the camera images at least temporarily,
wherein the control and/or regulation unit comprises a trained machine-learning algorithm which is at least configured to carry out, on the basis of the evaluated camera images, a coordinate recognition which comprises a recognition of tools, tool chucks, complete tools and/or tool and/or tool chuck pallets and a determination of the coordinates thereof in a fixed coordinate system.

### CROSS-REFERENCE TO RELATED APPLICATION

This patent application claims priority to and the benefit of German patent application DE 10 2024 104 907.3, filed on Feb. 21, 2024, the contents of which are incorporated herein by reference.

### PRIOR ART

The invention relates to a tool-presetting and/or tool-measuring system, a tool-presetting and/or tool-measuring method, a computer program product and a control and/or regulation unit.

A tool-measuring system, having an optical tool-presetting and/or tool-measuring apparatus, having at least one camera which is at least configured to capture camera images of a tool-measuring region of the tool-measuring apparatus and/or of a tool-storage, tool-retrieval or tool-intermediate-storage region of the tool-measuring system and having an, in particular external or internal, control and/or regulation unit which is at least configured to store and evaluate the camera images at least temporarily, has already been proposed.

The objective of the invention is, in particular, to provide a generic system having advantageous operating properties. The objective is achieved according to the invention.

### ADVANTAGES OF THE INVENTION

The invention is based on a tool-presetting and/or tool-measuring system having an optical tool-presetting and/or tool-measuring apparatus, having at least one camera which is at least configured to capture camera images of a tool-presetting and/or tool-measuring region of the tool-presetting and/or tool-measuring apparatus and/or of a tool-storage, tool-retrieval or tool-intermediate-storage region of the tool-presetting and/or tool-measuring system, and having an, in particular external or internal, control and/or regulation unit which is at least configured to store and evaluate the camera images at least temporarily.

It is proposed that the control and/or regulation unit comprises a trained machine-learning algorithm which is at least configured to carry out, on the basis of the evaluated camera images, a coordinate recognition which comprises a recognition of tools, tool chucks, complete tools and/or tool and/or tool chuck pallets and a determination of the coordinates thereof in a fixed coordinate system. Advantageous operating properties for the tool-presetting and/or tool-measuring system can thereby be achieved. Operational reliability can advantageously be increased. Operational efficiency can advantageously be increased. A speed of the tool-presetting and/or tool-measuring system can advantageously be increased. Operating costs can advantageously be reduced. The machine-learning algorithm is preferably a machine-learning algorithm which is specialized in a recognition of objects from camera images.

The tool-presetting and/or tool-measuring system can be embodied as a sole tool-measuring system, for example a “coraMeasure LG” system of the model year 2023 of the company E. ZOLLER GmbH & Co. KG Einstell- und Messgeräte (Pleidelsheim, Germany), as a sole tool-presetting system or as a tool-presetting and tool-measuring system, for example a “roboBox” system of the model year 2023 of the company E. ZOLLER GmbH & Co. KG Einstell- und Messgeräte (Pleidelsheim, Germany). In particular, a sole tool-measuring system is embodied as a standalone tool-measuring system for measuring tools for use in machine tools, which is preferably separate and independent from the machine tool. In particular, the standalone tool-measuring system comprises an optical tool-measuring apparatus. In particular, a sole tool-presetting system is embodied as a standalone tool-presetting system for adjusting, e.g. length-adjusting, tools for use in machine tools, which is preferably separate and independent from the machine tool. In particular, the standalone tool-presetting system comprises a tool-presetting apparatus. In particular, a tool-presetting and tool-measuring system also comprises, inter alia, a tool-measuring system. In particular, a tool-presetting and tool-measuring system also comprises, inter alia, a tool-presetting system. The camera is embodied in particular as a reflected-light camera. The camera can be part of a camera system composed of switchable illumination and camera sensor. “Configured” is to be understood in particular to mean specifically programmed, designed and/or equipped. The fact that an object is configured for a specific function is to be understood in particular to mean that the object fulfills and/or carries out this specific function in at least one application state and/or operating state. A “tool-presetting and/or tool-measuring apparatus” is to be understood in particular to mean an apparatus which is at least configured to at least partially detect at least one length, at least one angle, at least one contour and/or at least one outer shape of a tool and/or to adjust the tool in a tool chuck. Preferably, the tool-presetting and/or tool-measuring apparatus has a setting and/or measuring precision in the region of micrometers or below.

A tool-presetting and/or tool-measuring region of the tool-presetting and/or tool-measuring apparatus is embodied in particular as a region in which the tool is positioned when carrying out a main function, for example a tool-measuring function or a tool-setting function, of the tool-presetting and/or tool-measuring apparatus. A tool-storage region is embodied in particular as a region in which a tool is arranged before carrying out the main function of the tool-presetting and/or tool-measuring apparatus and is preferably configured for carrying out the main function of the tool-presetting and/or tool-measuring apparatus. A tool-retrieval region is embodied in particular as a region in which a tool is arranged after carrying out the main function of the tool-presetting and/or tool-measuring apparatus and is preferably configured for further transport after carrying out the main function of the tool-presetting and/or tool-measuring apparatus. A tool-intermediate storage region is embodied in particular as a region in which a tool is arranged during various steps of an operation of the tool-presetting and/or tool-measuring apparatus and is preferably configured for further measuring and/or setting steps of the operation of the tool-presetting and/or tool-measuring apparatus which still follow. A “control and/or regulation unit” is to be understood in particular to mean a unit having at least one control electronics unit. A “control electronics unit” is to be understood in particular to mean a unit having a processor unit, in particular a processor, and having a memory unit, in particular a data memory, and having an operating program stored in the memory unit. Preferably, the control and/or regulation unit is a computer. In particular, the memory unit is at least configured to temporarily or permanently store the camera images. In particular, the processor unit is at least configured to carry out the evaluation of the stored camera images. The control and/or regulation unit can be part of the tool-presetting and/or tool-measuring system, in particular a component of the tool-presetting and/or tool-measuring system such as, for example, the tool-presetting and/or tool-measuring apparatus. Alternatively or additionally, at least a part of the control and/or regulation unit or the entire control and/or regulation unit can be arranged externally, that is to say, for example, in a cloud or in an external data center, wherein there is preferably a communication link to components of the tool-presetting and/or tool-measuring system, such as an industrial handling robot, the camera or the tool-presetting and/or tool-measuring apparatus.

The machine-learning algorithm preferably applies known deep-learning techniques. The machine-learning algorithm is preferably trained specifically on the recognition of tools, in particular from a defined group of tools, of tool chucks, in particular from a defined group of tool chucks, of mounted complete tools, in particular from a defined group of mounted complete tools, and/or of tool and/or tool chuck pallets, in particular from a defined group of tool and/or tool chuck pallets. The machine-learning algorithm is preferably a machine-learning algorithm which is specialized in a recognition of objects from camera images. The object recognition from images is one of the main disciplines of machine learning, with the result that the training and/or the application of corresponding machine-learning algorithms lies within the area of the specialist knowledge of the person skilled in the art (see, inter alia, https://en.wikipedia.org/wiki/Outline_of_object_recognition, prior: revision of 30 Oct. 2023—12:14a.m.).

If the trained machine-learning algorithm, which is based, in particular, on an application of a deep-learning technique, is a CNN (convolutional neural network) algorithm, advantages can be achieved, in particular, in a processing of relatively large data quantities in the course of the object recognition on the basis of the camera images. In addition, advantages can also be achieved thereby in an object recognition of suboptimal camera images which have image distortions and/or different illumination conditions. In addition, a memory space requirement can advantageously be kept low in comparison with other neural networks. For example, one of the known CNN algorithms described in the following publications can be used in the tool identification method: a) AlexNet: Alex Krizhevsky, Imagenet classification with deep convolutional neural networks, Communications of the ACM 60.6, pg. 84-90 (2017); b) MobileNet: Andrew G. Howard, MobileNets: Efficient Convolutional Neural Networks for Mobile Vision Applications, CoRR, abs/1704.04861, (2017); c) Xception: Francois Chollet, Xception: Deep Learning with Depthwise Separable Convolutions, CoRR, abs/1610.02357, (2016); d) LeCun Y, Bengio Y, Hinton G (2015) Deep learning; Nature 521: 436{444, DOI 10.1038/044539; e) Lin H, Li B, Wang X, Shu Y, Niu S (2019); Automated defect inspection of LED chip using deep convolutional neural network; J Intell Manuf; 30:2525 {2534, DOI 10.1007/sl0845-018-1415-x; f) Fu G, Sun P, Zhu W, Yang J, Cao Y, Yang Y, Cao Y (2019); A deep-learning-based approach for fast and robust steel surface defects classification; Opt Laser Eng 121: 397{405, DOI 10.1016/j.optlaseng.2019.05.005; g) Lee K B, Cheon S, Kim C O (2017) A Convolutional Neural Network for Fault Classification and Diagnosis in Semiconductor Manufacturing Processes; IEEE T Semiconduct M 30:135{142, DOI 10.1109/TSM.2017.2676245; h) Goncalves D A, Stemmer M R, Pereira M (2020) A convolutional neural network approach on bead geometry estimation for a laser cladding system; Int J Adv Manuf Tech 106:1811{1821, DOI 10.1007/s00170-019-04669-z; i) Karatas A, Kölsch D, Schmidt S, Eier M, Seewig J (2019) Development of a convolutional autoencoder using deep neuronal networks for defect detection and generating ideal references for cutting edges; Munich, Germany, DOI 10.1117/12.2525882; j) Stahl J, Jauch C (2019) Quick roughness evaluation of cut edges using a convolutional neural network; In: Proceedings SPIE 11172, Munich, Germany, DOI 10.1117/12.2519440; or k) a CNN of the open source framework known under the name “TensorFlow”. Alternative CNN algorithms which are known to the person skilled in the art, such as, for example, Region Proposals (R-CNN, Fast R-CNN, Faster R-CNN), Detectron, Single Shot MultiBox Detector (SSD) or You Only Look Once (YOLO, for example in the version number 8 which can be licensed at the registration time), etc. are of course likewise conceivable. Simple open-source solutions are available for the application of many of these machine-learning algorithms (cf. the article from the online lexicon “Wikipedia” which has already been referenced above). In particular, the trained machine-learning algorithm is executed by the processor unit of the control and/or regulation unit. In particular, the trained machine-learning algorithm is stored on the memory unit of the control and/or regulation unit. The control and/or regulation unit comprises, in particular, an information input for receiving the camera images, an information processing for analyzing the camera images and an information output at least for outputting control and/or regulation commands based on the results of the evaluation to further components of the tool-presetting and/or tool-measuring system, such as the industrial handling robot or the tool-presetting and/or tool-measuring apparatus, etc. Advantageously, the control and/or regulation unit additionally has at least input and output means, further electrical components, an operating program, regulation routines, control routines and/or calculation routines. Preferably, the components of the control and/or regulation unit are arranged on a common circuit board and/or are advantageously arranged in a common housing. Alternatively, however, the control and/or regulation unit can also be embodied as a distributed computing unit, such as, for example, a cloud. In particular, the trained machine-learning algorithm comprises an object classification algorithm.

The machine-learning algorithm can additionally be configured for determining the coordinates of the recognized objects. Preferably, the machine-learning algorithm (comparable to the above-described training of the object recognition) is trained to determine the coordinates of the recognized objects on the basis of the recognized object types in interaction with the camera images. Alternatively, however, the determination of the coordinates of the recognized objects can take place in the fixed coordinate system by means of mathematical calculations from the dimensions of the recognized object in the camera image or a combination of a plurality of camera images recorded from different positions. For this purpose, an exact position and/or relative position of the recognized object is known to the control and/or regulation unit, for example via a calibrated distance of the camera from the tool-presetting and/or tool-measuring region, the tool-storage region, the tool-retrieval region and/or the tool-intermediate-storage region. A complete tool comprises in particular a combination of tool chuck and tool which is specifically matched to one another and/or belongs together and which can in particular be removed. A tool and/or tool chuck pallet is embodied in particular as a planar holding device and/or bearing device for holding and/or bearing tools and/or tool chucks, which preferably comprises a plurality of columns and/or rows of receiving places for tools and/or tool chucks. The tools are embodied in particular as shank tools, preferably as rotary shank tools, for example drills, milling cutters, profile tools and/or reamers, wherein a shank of the shank tools is preferably configured for mounting in a tool receptacle. A “tool chuck” is to be understood in particular to mean a component which is configured for receiving a tool and for connecting the tool to a machine. In particular, the tool chuck is embodied as an interface between the tool and the machine. For example, the tool chuck is embodied as a shrink chuck, as a hydroexpansion chuck, as a press chuck, as a collet chuck or the like. The fixed coordinate system can be, for example, a coordinate system of an industrial handling robot of the tool-presetting and/or tool-measuring system.

If the camera is a measuring camera, in particular a reflected-light measuring camera, of the tool-presetting and/or tool-measuring apparatus, a high efficiency can advantageously be achieved. Costs and/or component numbers can advantageously be kept low. A simple construction can advantageously be achieved. A further function can advantageously be assigned to an already existing component. In particular, the measuring camera is different from a transmitted-light camera, in particular a transmitted-light measuring camera of a tool-presetting and/or tool-measuring apparatus. A transmitted-light camera is to be understood here as a camera which records a shadow crack of an object (illuminated from behind). A reflected-light camera is to be understood here as a camera whose images are predominantly formed by a reflection of an object, in particular illuminated by the illumination of the camera system. The measuring camera of the tool-presetting and/or tool-measuring apparatus is in particular configured at least for measuring tools, tool chucks and/or complete tools. The measuring camera of the tool-presetting and/or tool-measuring apparatus is a camera used for carrying out the main function of the tool-presetting and/or tool-measuring apparatus.

Furthermore, it is proposed that the control and/or regulation unit is configured to determine, by means of the coordinate recognition, at least one dimension of the respective tools, tool chucks, complete tools and/or tool and/or tool chuck pallets. As a result, a space requirement can advantageously be determined, for example for a movement of the recognized object within the tool-presetting and/or tool-measuring system. In addition, a fit of the object with a further object or a storage place or the like can advantageously be determined. The dimension is in particular a height, a width, a depth and/or a volume of the recognized object. The dimension can be determined with the aid of the machine-learning algorithm. Alternatively, the dimension can also be determined by means of a dimension calculation based on the perspective of the camera. In particular, in this case, in the case of the coordinate recognition, the dimension is determined after a recognition of the respective object. In particular, in this case, the dimension calculation can be supported and/or checked by information which can be detected by means of the object recognition. For example, for this purpose, known standard dimensions of specific tools, tool chucks, complete tools and/or tool and/or tool chuck pallets can be stored in the control and/or regulation unit.

Furthermore, it is proposed that the control and/or regulation unit is configured to determine, by means of the coordinate recognition, at least one position of the respective tools, tool chucks, complete tools and/or tool and/or tool chuck pallets. As a result, a collision-free gripping of recognized objects and/or a collision-free movement trajectory for moving the objects within the tool-presetting and/or tool-measuring system can advantageously be determined. In addition, a positioning of objects relative to one another can advantageously be made possible. The position is, in particular, a spatial position/a coordinate/a coordinate region within the fixed coordinate system. The position can be determined with the aid of the machine-learning algorithm. Alternatively, the position can also be determined by means of a dimension calculation based on the perspective/perspectives of the camera/s. In particular, in this case, in the case of the coordinate recognition, the position is determined after a recognition of the respective object. In particular, in this case, the position calculation can be supported and/or checked by information which can be detected by means of the object recognition. For example, for this purpose, known standard dimensions of specific tools, tool chucks, complete tools and/or tool and/or tool chuck pallets can be stored in the control and/or regulation unit. Preferably, the control and/or regulation unit is configured to output at least a part of the variable detected in the coordinate recognition, such as the object type, the dimension and/or the position, for example to another component of the tool-presetting and/or tool-measuring system, such as the industrial handling robot, or to an external component, such as a machine tool or a tool management system.

If the tool-presetting and/or tool-measuring system has the industrial handling robot having at least one gripper unit for gripping and/or moving tools, tool chucks and/or complete tools, a particularly efficient operation, in particular equipping, of the tool-presetting and/or tool-measuring system can advantageously be made possible. An industrial handling robot is in particular a universal, programmable machine for handling, mounting and/or machining workpieces/objects. The industrial handling robot can be, for example, a 5-axis industrial robot or a 6-axis industrial robot (in each case standing or suspended). The industrial handling robot can also be, for example, a room gantry robot.

In addition, it is proposed that the control and/or regulation unit is configured to determine, by means of the coordinate recognition, at least one position of the gripper unit and to compare at least the recognized positions of tool and/or tool chuck pallets and gripper unit with numerical control data of an actuation of the gripper unit, preferably to transform position data of the recognized positions of tool and/or tool chuck pallets into numerical control data of the actuation of the gripper unit. A high operational reliability can thereby advantageously be achieved. A particularly exact and/or reliable navigation of the gripper unit in the tool-presetting and/or tool-measuring system can advantageously be achieved.

To this end, it is proposed that the camera images comprise at least a part of a movement range of the gripper unit, preferably a complete movement range of the gripper unit. A high operational reliability can thereby advantageously be achieved. A particularly exact and/or reliable navigation of the gripper unit in the tool-presetting and/or tool-measuring system can advantageously be achieved. The movement range of the gripper unit is formed by the totality of all points which the gripper unit can reach in space, in particular depending on the current programming and/or teaching.

It is additionally proposed that the trained machine-learning algorithm of the control and/or regulation unit or a further correspondingly trained machine-learning algorithm of the control and/or regulation unit is configured to recognize, from the camera images within the tool-presetting and/or tool-measuring system, gripper unit learning markings which are configured for defining limits of the movement range of the gripper unit and which form reference positions for a reference travel of the industrial handling robot, in particular a reference travel which is carried out automatically. A high efficiency can thereby advantageously be achieved. A manual reference travel of the industrial handling robot can advantageously be dispensed with. A teaching process of the industrial handling robot can advantageously be accelerated. A high operational reliability can advantageously be achieved. The further machine-learning algorithm can be based on the same principles as the machine-learning algorithm, wherein only other training data (gripper unit learning markings) have been used. The industrial handling robot is configured to approach the positions of the gripper unit learning markings, preferably in a sequence read out from the gripper unit learning markings, and to calculate the respective associated coordinates and/or to store them as numerical control data, preferably in the fixed coordinate system. It is also conceivable that the industrial handling robot approaches the gripper unit learning markings out of sequence, but stores them in the reference point sequence read out from the gripper unit learning markings.

Furthermore, it is proposed that the control and/or regulation unit is configured to carry out, by means of the coordinate recognition, a collision check on the basis of a determination of relative positionings of tool and/or tool chuck pallets recognized in the camera images and of all positions to be approached by the gripper unit for equipping holding places, in particular holding places of the recognized tool and/or tool chuck pallets which are recognized as being unoccupied. A high operational reliability can thereby advantageously be achieved. In addition, a high efficiency can advantageously be achieved, in particular by free holding places being able to be approached more precisely and/or more quickly. In particular, the tool-presetting and/or tool-measuring system, in particular the control and/or regulation unit, knows by the coordinate recognition which holding places of the tool and/or tool chuck pallets are occupied and which are free, which space the objects arranged in the holding places of the tool and/or tool chuck pallet occupy and which space the gripper unit and any objects currently held therein occupy. A limitation of all permitted, collision-avoiding positions of the gripper unit can thereby be carried out. As a result, the control and/or regulation unit then permits only an actuation of the gripper unit positions lying within this limitation. As a result, the control and/or regulation unit then prevents any movements of the gripper unit which would produce an exceeding of this limitation by the gripper unit and/or by an object held by the gripper unit. In particular, the data detected in the coordinate recognition are thus used for the collision check during a loading and/or during an unloading of tool and/or tool chuck pallets. For example, it can advantageously be made possible by the coordinate recognition that, after an interruption in operation, for example as a result of a power failure, an automated and collision-free continuation of the loading and unloading process of tool and/or tool chuck pallets is made possible, even if a current progress of a process or a current positioning and/or loading state of the gripper unit and of the tool and/or tool chuck pallet has been lost. A recognition of an incorrectly positioned or incorrectly oriented pallet can advantageously be made possible by the determination of the relative positioning of tool and/or tool chuck pallet and gripper unit.

Furthermore, it is proposed that the control and/or regulation unit is configured to determine optimal movement paths, in particular shortest movement paths and/or movement paths provided with a simplest movement sequence, for the gripper unit for approaching at least one unoccupied holding place, and in particular to output them to an actuation of the gripper unit. An efficiency can thereby advantageously be increased. A more direct approaching of holding places can advantageously be made possible. Movement paths of the gripper unit can advantageously be shortened. An energy consumption of the gripper unit can thereby advantageously be reduced and/or a service life of the gripper unit can advantageously be increased. For example, in the case of an implementation of the industrial handling robot as a room gantry robot, a gripping height necessary for driving over all objects stored in a tool and/or tool chuck pallet could be optimized. If only relatively short objects are stored, the set driving-over height can be lower than if long objects are also stored. In the case of a recognition of unoccupied places, the gripper unit also does not first have to be moved laterally or vertically out of the region of the tool and/or tool chuck pallets for each movement. Unnecessary detours of the gripper unit can thereby advantageously be avoided. In particular, the control and/or regulation unit can be configured to output the optimized actuation of the gripper unit determined in this way in the form of numerical control data to the gripper unit. In particular, the optimal movement paths of the gripper unit are different from fixed and invariably predefined/programmed gripper unit movement sequences.

Furthermore, it is proposed that the control and/or regulation unit is configured to determine, by means of the coordinate recognition, an occupation situation of holding places of the tool and/or tool chuck pallets. A loading or unloading time for an insertion or removal of an object into or from the tool and/or tool chuck pallet can advantageously be reduced by the proposed recognition of unoccupied holding places. The gripper unit can advantageously dispense with a “blind” testing of the occupation of each individual place lying in between. In addition, a risk of an already occupied place being approached, for example by an incorrect programming of the gripper unit, can advantageously be reduced. In addition, a comparison with a tool management system can advantageously take place by the occupation recognition of holding places, so that missing or additionally existing tools, tool chucks and/or complete tools can be recognized.

In addition, it is proposed that the tool-presetting and/or tool-measuring system has at least one further camera which is at least configured to capture further camera images of the tool-presetting and/or tool-measuring region of the tool-presetting and/or tool-measuring apparatus, of the tool-storage, tool-retrieval or tool-intermediate-storage region and/or of at least a part of a movement range of the gripper unit, preferably a complete movement range of the gripper unit, wherein the trained machine-learning algorithm of the control and/or regulation unit is configured to carry out the coordinate recognition on the basis of a combined evaluation of the camera images of the camera and of the further camera images of the further camera. The further camera can be used to enlarge an overall detection region of the tool-presetting and/or tool-measuring system that can be evaluated for the coordinate recognition. Alternatively or additionally, the further camera can be used for a 3-D detection. As a result, the coordinate recognition can advantageously be made more precise and/or a detection region covered by the cameras can be enlarged. In particular, the precision of the determination of the positions and/or the dimensions of the recognized objects can be increased. In particular, the camera images of camera and further camera are used for a determination of 3-D data. In particular, the control and/or regulation unit is configured for a 3-D coordinate recognition based on a combination of camera images of the camera and of the further camera. In particular, the positions of the cameras and their camera settings, such as zoom, angle, field of view, etc., are calibrated and stored in the control and/or regulation unit.

Furthermore, it is proposed that at least one further measuring sensor of the tool-presetting and/or tool-measuring apparatus which is different from the camera, and in particular from the further camera, is configured to be used by the control and/or regulation unit when carrying out the coordinate recognition. As a result, the coordinate recognition can advantageously be made more precise. The measuring sensor which is different from the camera and from the further camera is preferably based on a non-optical measuring principle. However, it is also conceivable that the further measuring sensor is based on an optical measuring principle which, however, is different from an incident-light camera image.

Alternatively or additionally, it is proposed that at least one further measuring sensor of the tool-presetting and/or tool-measuring apparatus which is different from the camera, and in particular from the further camera, is configured to be used by the control and/or regulation unit for a plausibility check of the data determined in the coordinate recognition, such as, for example, positions, dimensions, etc. As a result, the coordinate recognition can advantageously be verified. A high operational reliability can advantageously be achieved. In particular, for the plausibility check, dimensions and/or positions of objects are determined from measurement data of the further measuring sensor and are compared with the measurement results determined in the coordinate recognition. In the event of a deviation, for example, a warning message can be output, a measurement can be repeated and/or an operation of the tool-presetting and/or tool-measuring system can be paused.

If the further measuring sensor is a laser triangulation sensor of the tool-presetting and/or tool-measuring apparatus, a tactile probe of the tool-presetting and/or tool-measuring apparatus, a Twip sensor of the tool-presetting and/or tool-measuring apparatus or a transmitted-light camera of the tool-presetting and/or tool-measuring apparatus, a reliable precision of the coordinate recognition and/or a reliable plausibility check of the coordinate recognition can advantageously be made possible. In this case, the Twip sensor is embodied in particular as a confocal microscope sensor for 3-D surface detection, for example with a rotating microlens disk, as is sold under the designation CONSIGNO by the company Twip Optical Solutions (Pleidelsheim, Germany). The transmitted-light camera is in particular a camera system which has a planar background illumination, by means of which a shadow-crack image of outer contours of objects can be obtained. In the transmitted-light camera, the object to be recorded is positioned between the surface light and a camera sensor aligned with the surface light. The tactile probe is in particular a sensor feeler which is configured to touch/sweep over a surface of the object to be sensed and thereby to obtain information about a condition of the object.

Furthermore, it is proposed that at least one further operating parameter of a component of the tool-presetting and/or tool-measuring system which is different from a sensor measured value, for example a power consumption of a gripper unit of the tool-presetting and/or tool-measuring system or of a rotation unit of the tool-presetting and/or tool-measuring apparatus, is configured to be used by the control and/or regulation unit for a plausibility check of the data determined in the coordinate recognition, such as, for example, dimensions of tools, tool chucks, complete tools and/or tool and/or tool chuck pallets. As a result, the coordinate recognition can advantageously be verified. A high operational reliability can advantageously be achieved. In particular, a plausibility is determined in that an expected value for the operating parameter, that is to say, for example, an expected power consumption of the gripper unit and/or of the rotation unit, is compared with a measured power consumption of the gripper unit and/or of the rotation unit and is checked for substantial deviations. In the event of a recognition of a substantial deviation, for example, a warning message can be output, a measurement can be repeated and/or an operation of the tool-presetting and/or tool-measuring system can be paused. For example, a weight deviation of an object can produce a power consumption deviation of the gripper unit. For example, a strong geometry deviation of an object can produce a power consumption deviation of the gripper unit on account of changed lever ratios. For example, a shape deviation of an object or an incorrect positioning of an object in the rotation unit can produce a power consumption deviation by a deviating concentricity and/or a deviating inertia of the rotation unit. The rotation unit is preferably embodied as a tool and/or tool chuck holder, for example a spindle unit of the tool-presetting and/or tool-measuring apparatus.

In addition, it is proposed that the control and/or regulation unit, in particular the trained machine-learning algorithm of the control and/or regulation unit, is configured to recognize, at least on the basis of the camera images, at least a presence of an operator, in particular in a close region of the tool-presetting and/or tool-measuring system and/or the tool-measuring region, and preferably to determine location coordinates of the operator. A particularly high operational reliability and/or operator reliability can advantageously be achieved as a result. In addition, an efficiency can advantageously be maximized. In particular, the control and/or regulation unit, preferably the machine-learning algorithm of the control and/or regulation unit, comprises a person recognition function. In particular, the coordinate recognition is configured to determine, at least roughly, the location coordinates of the operator and/or a distance of the operator from the tool-measuring region. The camera images can be embodied in particular as still images or as moving images.

If, in this case, the control and/or regulation unit or a further control unit of the tool-presetting and/or tool-measuring system is configured to adapt a system parameter, in particular a movement speed of at least one component of the tool-presetting and/or tool-measuring system, such as, for example, of a rotation unit of the tool-presetting and/or tool-measuring apparatus, of a clamping mechanism of a tool and/or tool chuck holding unit of the tool-presetting and/or tool-measuring apparatus or of a gripper unit of the tool-presetting and/or tool-measuring system, depending on the recognized presence or absence of the operator, in particular depending on a recognized location coordinate of an operator present, an efficiency can advantageously be substantially increased. In particular, the movement speed is increased if an absence of the operator or a sufficient distance of the operator from the object is determined. In particular, the movement speed is reduced or the movement is completely stopped or prevented if a presence of the operator or an inadequate distance of the operator from the object is determined.

Furthermore, a preferably computer-implemented tool-presetting and/or tool-measuring method, in particular by means of the tool-presetting and/or tool-measuring system, is proposed, wherein, in at least one method step, the camera, in particular of the optical tool-presetting and/or tool-measuring apparatus, captures camera images of a tool-presetting and/or tool-measuring region of the tool-presetting and/or tool-measuring apparatus and/or of a tool-storage, tool-retrieval or tool-intermediate-storage region, wherein, in at least one further method step, the camera images are at least temporarily stored and evaluated by the control and/or regulation unit, and wherein, in at least one further method step, the coordinate recognition is carried out by the trained machine-learning algorithm on the basis of the evaluated camera images, which coordinate recognition comprises a recognition of tools, tool chucks, complete tools and/or tool and/or tool chuck pallets and a determination of the coordinates thereof in the fixed coordinate system. Advantageous operating properties for the tool-presetting and/or tool-measuring system can thereby be achieved. Operational reliability can advantageously be increased. Operational efficiency can advantageously be increased. A speed of the tool-presetting and/or tool-measuring system can advantageously be increased. Operating costs can advantageously be reduced.

In addition, a computer program product and/or a computer program computing infrastructure, comprising commands which, when the computer program is executed by a computing unit, preferably the control and/or regulation unit of the tool-presetting and/or tool-measuring system, cause said computing unit to execute the steps of the tool identification method, which steps comprise the execution of the trained machine-learning algorithm, and/or the corresponding control and/or regulation unit for the tool-presetting and/or tool-measuring system comprising the computer program product, is proposed. Operational reliability can advantageously be increased. Operational efficiency can advantageously be increased.

The tool-presetting and/or tool-measuring system according to the invention, the tool-presetting and/or tool-measuring method according to the invention, the computer program product according to the invention and the control and/or regulation unit according to the invention are not intended to be restricted here to the application and embodiment described above. In particular, the tool-presetting and/or tool-measuring system according to the invention, the tool-presetting and/or tool-measuring method according to the invention, the computer program product according to the invention and the control and/or regulation unit according to the invention can have a number of individual elements, components and units differing from a number mentioned herein in order to fulfill a functionality described herein.

### DRAWINGS

Further advantages result from the following description of the drawings. An exemplary embodiment of the invention is shown in the drawings. The drawings, the description and the claims contain numerous features in combination. The person skilled in the art will expediently also consider the features individually and combine them into meaningful further combinations.

In the drawings:

FIG. 1 schematically and perspectively shows a tool-presetting and/or tool-measuring system,

FIG. 2 shows a schematic side view of a tool clamped in a tool chuck, and

FIG. 3 shows a schematic flow diagram of a tool-presetting and/or tool-measuring method with the tool-presetting and/or tool-measuring system.

### DESCRIPTION OF THE EXEMPLARY EMBODIMENT

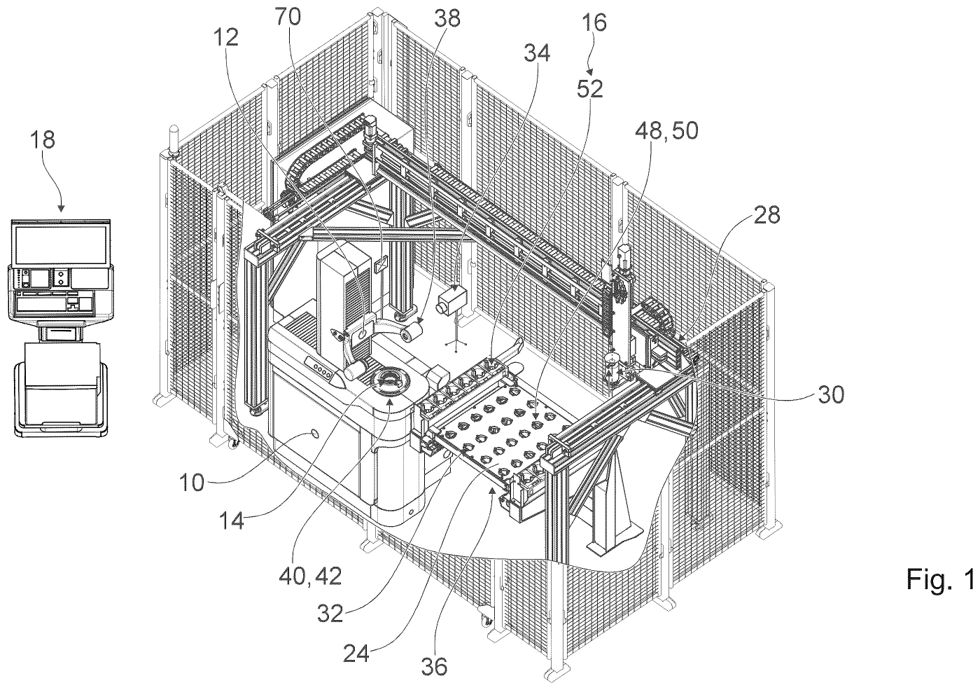

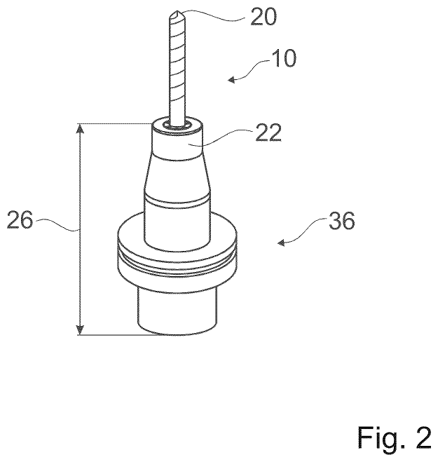

FIG. 1 shows an exemplary tool-presetting and/or tool-measuring system 16. Alternative implementations of tool-presetting and/or tool-measuring systems 16, such as, for example, the already mentioned “roboBox”, which is described, inter alia, in the European patent with the number EP 3 747 596 B1, are likewise in accordance with the described invention. The tool-presetting and/or tool-measuring system 16 has an optical tool-presetting and/or tool-measuring apparatus 10. The tool-presetting and/or tool-measuring apparatus 10 forms a tool-presetting and/or tool-measuring region 14. The tool-presetting and/or tool-measuring apparatus 10 is configured at least for measuring tools 20, tool chucks 22 (cf. FIG. 2) and/or complete tools which are arranged within the tool-presetting and/or tool-measuring region 14. The tool-presetting and/or tool-measuring apparatus 10 has a tool and/or tool chuck holding unit 42. The tool and/or tool chuck holding unit 42 is configured for fixing the tool 20, tool chuck 22 or complete tool within the tool-presetting and/or tool-measuring region 14. The tool-presetting and/or tool-measuring apparatus 10 has a rotation unit 40. The rotation unit 40 is configured for rotating the tool 20, tool chuck 22 or complete tool held in the tool and/or tool chuck holding unit 42. The rotation unit 40 is embodied as a spindle unit with attachment holder of the tool-presetting and/or tool-measuring apparatus 10. The tool-presetting and/or tool-measuring system 16 has an industrial handling robot 28. In the implementation of FIG. 1, the industrial handling robot 28 is embodied, for example, as a room gantry robot. Other forms and types of industrial handling robots 28 would, of course, also be conceivable as an alternative. The industrial handling robot 28 has a gripper unit 30. The gripper unit 30 is configured for gripping and/or moving the tools 20, tool chucks 22 and/or complete tools. The gripper unit 30 is configured for moving the tools 20, tool chucks 22 and/or complete tools between various components and/or regions of the tool-presetting and/or tool-measuring system 16.

The tool-presetting and/or tool-measuring system 16 additionally forms a tool-storage region 48. Tool and/or tool chuck pallets 24 can be positioned in the tool-storage region 48. The tool and/or tool chuck pallets 24 comprise holding places 32 for receiving tools 20, tool chucks 22 and/or complete tools. The tool-storage region 48 is configured to provide tools 20, tool chucks 22 and/or complete tools for subsequent measurement and/or adjustment by the tool-presetting and/or tool-measuring apparatus 10. The tools 20, tool chucks 22 and/or complete tools are preferably provided in the holding places 32 of the tool and/or tool chuck pallet 24.

The tool-presetting and/or tool-measuring system 16 additionally forms a tool-retrieval region 50. Tool and/or tool chuck pallets 24 can be positioned in the tool-retrieval region 50. The tool-retrieval region 50 is configured for receiving tools 20, tool chucks 22 and/or complete tools which have been measured and/or adjusted by the tool-presetting and/or tool-measuring apparatus 10. The measured tools 20, tool chucks 22 and/or complete tools are preferably inserted into the holding places 32 of the tool and/or tool chuck pallet 24. The tool-retrieval region 50 is embodied identically to the tool-storage region 48 in the exemplary embodiment shown in FIG. 1. However, separate tool-retrieval regions 50 and tool-storage regions 48 could also be provided which are each equipped, for example, with a tool and/or tool chuck pallet 24. The tool-presetting and/or tool-measuring system 16 additionally forms a tool-intermediate-storage region 52. The tool-intermediate-storage region 50 is configured for receiving tools 20, tool chucks 22 and/or complete tools which are located between various working steps of the tool-presetting and/or tool-measuring system 16.

The tool-presetting and/or tool-measuring apparatus 10 has a camera 12. The camera 12 is configured to capture camera images of the tool-presetting and/or tool-measuring region 14, of the tool-storage region 48, of the tool-retrieval region 50 and/or of the tool-intermediate-storage region 52. The camera 12 is a reflected-light camera. The camera 12 is a measuring camera, in particular a reflected-light measuring camera, of the tool-presetting and/or tool-measuring apparatus 10. The measuring camera of the tool-presetting and/or tool-measuring apparatus 10 is configured for measuring the tools 20, tool chucks 22 and/or complete tools. The tool-presetting and/or tool-measuring apparatus 10 has a further camera 34. The further camera 34 is a reflected-light camera. The further camera 34 is embodied differently from a measuring camera of the tool-presetting and/or tool-measuring apparatus 10 and/or separately from the tool-presetting and/or tool-measuring apparatus 10. The further camera 34 is configured to capture further camera images of the tool-presetting and/or tool-measuring region 14, of the tool-storage region 48, of the tool-retrieval region 50 and/or of the tool-intermediate-storage region 52. The camera images and the further camera images each comprise at least a part of a movement range of the gripper unit 30. However, the camera images and/or the further camera images can also comprise the complete movement range of the gripper unit 30. It is also conceivable that the camera images and the further camera images only together comprise the complete movement range of the gripper unit 30. The camera images and the further camera images can additionally be combined for a determination of three-dimensional image data.

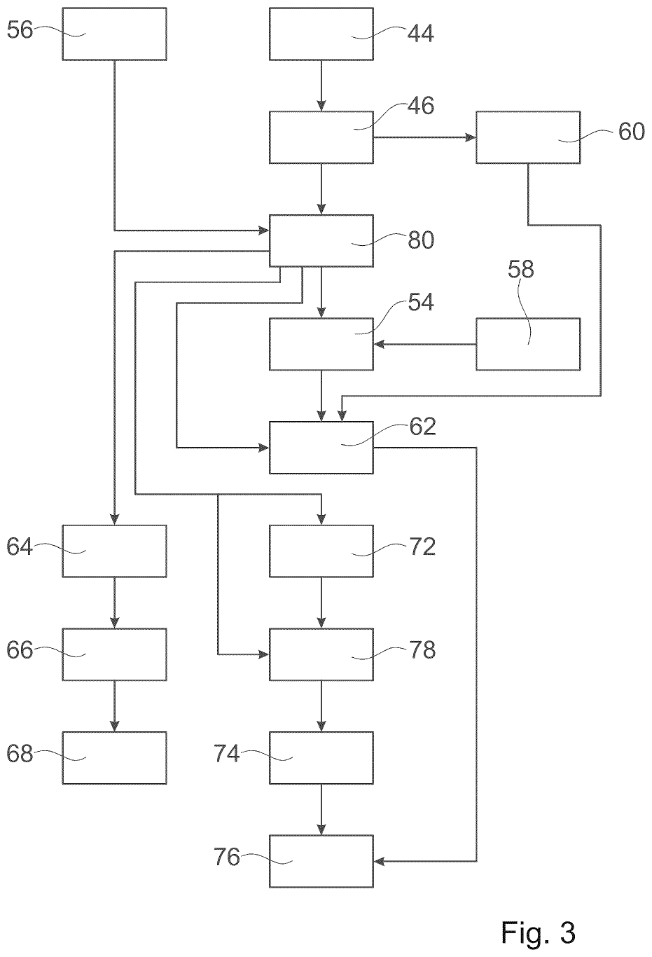

The tool-presetting and/or tool-measuring system 16 has a control and/or regulation unit 18. In the implementation of FIG. 1, the control and/or regulation unit 18 is embodied as a local part of the tool-presetting and/or tool-measuring system 16. Alternatively, however, the control and/or regulation unit 18 could also be embodied as an external or delocalized part of the tool-presetting and/or tool-measuring system 16. The control and/or regulation unit 18 is at least configured to store the camera images and/or the further camera images at least temporarily. The control and/or regulation unit 18 is at least configured to evaluate the camera images and/or the further camera images. The control and/or regulation unit 18 comprises a trained machine-learning algorithm. The trained machine-learning algorithm is at least configured to carry out, on the basis of the evaluated camera images, a coordinate recognition. The trained machine-learning algorithm is at least configured to carry out, on the basis of a combined evaluation of the camera images of the camera 12 and of the further camera images of the further camera 34, the coordinate recognition. The control and/or regulation unit 18 is configured at least with the aid of the camera 12 for carrying out, by means of the machine-learning algorithm, a tool-presetting and/or tool-measuring method described in conjunction with FIG. 3, in particular a computer-implemented tool-presetting and/or tool-measuring method, preferably a computer-implemented tool-presetting and/or tool-measuring method comprising an object recognition. The control and/or regulation unit 18 comprises a stored computer program product. The computer program product could also be stored on external data carriers or in a computer program computing infrastructure. The computer program product comprises a computer program with commands which, when executed by the control and/or regulation unit 18, cause said control and/or regulation unit to execute the steps of the described tool-presetting and/or tool-measuring method. The computer program product comprises a computer program with commands which, when executed by the control and/or regulation unit 18, cause said control and/or regulation unit to execute the machine-learning algorithm for recognizing objects in camera images of the camera 12. The computer program product comprises a computer program with commands which, when executed by the control and/or regulation unit 18, cause said control and/or regulation unit to execute the machine-learning algorithm for coordinate recognition.

The coordinate recognition comprises a recognition, in particular object recognition/type recognition, of the tools 20, tool chucks 22, complete tools and/or tool and/or tool chuck pallets 24. The coordinate recognition comprises a determination of spatial coordinates of the tools 20, tool chucks 22, complete tools and/or tool and/or tool chuck pallets 24 in a fixed coordinate system, preferably in an NC coordinate system of the industrial handling robot. The recognition, in particular object recognition/type recognition, of the tools 20, tool chucks 22, complete tools and/or tool and/or tool chuck pallets 24 is in this case carried out by the trained machine-learning algorithm. The machine-learning algorithm is trained specifically on the recognition of different tools 20, tool chucks 22, complete tools and/or tool and/or tool chuck pallets 24 from camera images. The trained machine-learning algorithm is a CNN (convolutional neural network) algorithm. The determination of the spatial coordinates of the tools 20, tool chucks 22, complete tools and/or tool and/or tool chuck pallets 24 in the fixed coordinate system can be carried out by the machine-learning algorithm or at least be supported by the machine-learning algorithm. The calculation of the spatial coordinates of the tools 20, tool chucks 22, complete tools and/or tool and/or tool chuck pallets 24 in the fixed coordinate system from the camera images and/or the further camera images can, however, also take place independently of the machine-learning algorithm.

The control and/or regulation unit 18 is configured to determine, by means of the coordinate recognition, at least one dimension 26 (cf. FIG. 2) of the respective tools 20, tool chucks 22, complete tools and/or tool and/or tool chuck pallets 24. The control and/or regulation unit 18 is configured to determine, by means of the coordinate recognition, at least one position 36 of the respective tools 20, tool chucks 22, complete tools and/or tool and/or tool chuck pallets 24. The control and/or regulation unit 18 is configured to determine, by means of the coordinate recognition, at least one position of the gripper unit 30 and to compare at least the recognized positions of tool and/or tool chuck pallets 24 and gripper unit 30 with numerical control data of an actuation of the gripper unit 30. The control and/or regulation unit 18 is configured to transform position data of the recognized positions of tool and/or tool chuck pallets 24 into numerical control data of the actuation of the gripper unit 30.

The control and/or regulation unit 18 is configured to carry out, by means of the coordinate recognition, a collision check on the basis of a determination of relative positionings of tool and/or tool chuck pallets 24 recognized in the camera images and of all positions to be approached by the gripper unit 30 for equipping holding places 32, in particular holding places 32 of the recognized tool and/or tool chuck pallets 24 which are recognized as being unoccupied. The control and/or regulation unit 18 is configured to determine optimal movement paths, in particular shortest movement paths and/or movement paths provided with a simplest movement sequence, for the gripper unit 30 for approaching at least one unoccupied holding place 32. The control and/or regulation unit 18 is configured to output the determined optimal movement paths to an actuation of the gripper unit 30. The control and/or regulation unit 18 is configured to determine, by means of the coordinate recognition, an occupation situation of holding places 32 of the tool and/or tool chuck pallets 24. The control and/or regulation unit 18, in particular the trained machine-learning algorithm of the control and/or regulation unit 18, is configured to recognize, at least on the basis of the camera images and/or the further camera images, at least a presence of an operator. The control and/or regulation unit 18, in particular the trained machine-learning algorithm of the control and/or regulation unit 18, is configured to determine, at least on the basis of the camera images and/or the further camera images, location coordinates of the operator recognized as being present.

The tool-presetting and/or tool-measuring system 16 has a further measuring sensor 38 which is different from the camera 12 and from the further camera 34. In the implementation of FIG. 1, the further measuring sensor 38 is embodied as a transmitted-light camera of the tool-presetting and/or tool-measuring apparatus 10. Alternatively or additionally, a further measuring sensor 38 can also be embodied as a laser triangulation sensor of the tool-presetting and/or tool-measuring apparatus 10, as a tactile probe of the tool-presetting and/or tool-measuring apparatus 10 or as a Twip sensor of the tool-presetting and/or tool-measuring apparatus 10.

FIG. 3 shows a schematic flow diagram of a tool-presetting and/or tool-measuring method using the tool-presetting and/or tool-measuring system 16. In at least one method step 44, the camera images are produced. In at least one method step 56, measuring parameters are captured by the further measuring sensor 38. In at least one method step 58, at least one operating parameter of at least one component of the tool-presetting and/or tool-measuring system 16 which is different from a sensor measured value is detected by the control and/or regulation unit 18. The detected operating parameter which is different from the sensor measured value can be embodied as a power consumption of the gripper unit 30 gripping a (recognized) tool 20, tool chuck 22 or complete tool, which is produced by the movements of the gripper unit 30. The detected operating parameter which is different from the sensor measured value can be a power consumption of the rotation unit 40 of the tool-presetting and/or tool-measuring apparatus 10. In at least one method step 60, the presence or absence of an operator in the camera images and/or in the further camera images is determined. In the case of a recognition of a presence of the operator, the location coordinates of the operator are determined in the method step 60.

In at least one further method step 46, the camera images are at least temporarily stored and evaluated by the control and/or regulation unit 18. In at least one further method step 80, the coordinate recognition is carried out by the trained machine-learning algorithm on the basis of the evaluated camera images. In the further method step 80, measuring parameters of the further measuring sensor 38 can be used by the control and/or regulation unit 18 when carrying out the coordinate recognition. In the further method step 80, at least dimensions 26 and/or positions 36 of the respective tools 20, tool chucks 22, complete tools and/or tool and/or tool chuck pallets 24 are determined by means of the coordinate recognition. In an additional further method step 54, a plausibility check of the information determined in the coordinate recognition is carried out. In the additional further method step 54, the measuring parameters of the further measuring sensor 38 can be used by the control and/or regulation unit 18 for the plausibility check of the data determined in the coordinate recognition, such as, for example, the positions 36 or the dimensions 26. In the additional further method step 54, the at least one detected operating parameter which is different from the sensor measured value can be used by the control and/or regulation unit 18 for the plausibility check of the data determined in the coordinate recognition, such as, for example, dimensions 26 of tools 20, tool chucks 22, complete tools and/or tool and/or tool chuck pallets 24. In at least one method step 62, a system parameter of the tool-presetting and/or tool-measuring system 16 is adapted by the control and/or regulation unit 18 depending on the recognized presence or absence of the operator. In the method step 62, the system parameter is adapted depending on the recognized location coordinate of the operator present. In this case, the system parameter can be embodied as a movement speed or as a system force of a component of the tool-presetting and/or tool-measuring system 16. The adaptation of the system parameter can be embodied as a reduction of the movement speed or of the system force of this component. For example, in the method step 62, a movement speed of the rotation unit 40, of a clamping mechanism of the tool and/or tool chuck holding unit 42 and/or of the gripper unit 30 is reduced depending on the recognized presence or absence of the operator.

In at least one further method step 64, gripper unit learning markings 70 which are arranged from the camera images and/or the further camera images within the tool-presetting and/or tool-measuring system 16 are recognized by the trained machine-learning algorithm of the control and/or regulation unit 18 or by a further correspondingly trained machine-learning algorithm of the control and/or regulation unit 18. The gripper unit learning markings 70 are configured for defining limits of the movement range of the gripper unit 30. For the sake of clarity, only one of a plurality of gripper unit learning markings 70 is shown schematically and by way of example in FIG. 1. In at least one further method step 66, the industrial handling robot 28 automatically carries out a reference travel with the positions of the recognized gripper unit learning markings 70 as reference positions. In at least one further method step 68, the coordinates of the reference travel are stored as numerical control data for a future operation of the industrial handling robot 28, preferably in the fixed coordinate system.

In at least one method step 72, a position of the gripper unit 30 and a recognized position 36 of a tool and/or tool chuck pallet 24 are compared with numerical control data of an actuation of the gripper unit 30. In the method step 72, the position data of the recognized position 36 of the tool and/or tool chuck pallet 24 are transformed into numerical control data of the actuation of the gripper unit 30. In at least one method step 78, an occupation situation of holding places 32 of the tool and/or tool chuck pallets 24 is determined by means of the coordinate recognition. In at least one method step 74, a collision check is carried out by means of the coordinate recognition on the basis of the determination of the relative positionings of the tool and/or tool chuck pallets 24 recognized in the camera images and of all positions to be approached by the gripper unit 30 for equipping holding places 32 of the recognized tool and/or tool chuck pallets 24 which are recognized as being unoccupied. In at least one method step 76, the optimal movement paths for the gripper unit 30 for approaching the unoccupied holding places 32 are determined and output to an actuation of the gripper unit 30.

1. A tool-presetting and/or tool-measuring system having an optical tool-presetting and/or tool-measuring apparatus, having at least one camera which is at least configured to capture camera images of a tool-presetting and/or tool-measuring region of the tool-presetting and/or tool-measuring apparatus and/or of a tool-storage, tool-retrieval or tool-intermediate-storage region of the tool-presetting and/or tool-measuring system, and having an, in particular external or internal, control and/or regulation unit which is at least configured to store and evaluate the camera images at least temporarily, wherein the control and/or regulation unit comprises a trained machine-learning algorithm which is at least configured to carry out, on the basis of the evaluated camera images, a coordinate recognition which comprises a recognition of tools, tool chucks, complete tools and/or tool and/or tool chuck pallets and a determination of the coordinates thereof in a fixed coordinate system.

2. The tool-presetting and/or tool-measuring system according to claim 1, wherein the camera is a measuring camera, in particular a reflected-light measuring camera, of the tool-presetting and/or tool-measuring apparatus.

3. The tool-presetting and/or tool-measuring system according to claim 1, wherein the trained machine-learning algorithm is a CNN (convolutional neural network) algorithm.

4. The tool-presetting and/or tool-measuring system according to claim 1, wherein the control and/or regulation unit is configured to determine, by means of the coordinate recognition, at least one dimension of the respective tools, tool chucks, complete tools and/or tool and/or tool chuck pallets.

5. The tool-presetting and/or tool-measuring system according to claim 1, wherein the control and/or regulation unit is configured to determine, by means of the coordinate recognition, at least one position of the respective tools, tool chucks, complete tools and/or tool and/or tool chuck pallets.

6. The tool-presetting and/or tool-measuring system according to claim 1, further comprising an industrial handling robot having at least one gripper unit for gripping and/or moving tools, tool chucks and/or complete tools.

7. The tool-presetting and/or tool-measuring system according to claim 5, further comprising an industrial handling robot having at least one gripper unit for gripping and/or moving tools, tool chucks and/or complete tools, wherein the control and/or regulation unit is configured to determine, in particular by means of the coordinate recognition, at least one position of the gripper unit and to compare at least the determined and/or recognized positions of tool and/or tool chuck pallets and gripper unit with numerical control data of an actuation of the gripper unit, preferably to transform position data of the recognized positions of tool and/or tool chuck pallets into numerical control data of the actuation of the gripper unit.

8. The tool-presetting and/or tool-measuring system according to claim 6, wherein the camera images comprise at least a part of a movement range of the gripper unit, preferably a complete movement range of the gripper unit.

9. The tool-presetting and/or tool-measuring system according to claim 8, wherein the trained machine-learning algorithm of the control and/or regulation unit or a further correspondingly trained machine-learning algorithm of the control and/or regulation unit is configured to recognize, from the camera images within the tool-presetting and/or tool-measuring system, gripper unit learning markings which are configured for defining limits of the movement range of the gripper unit and which form reference positions for a reference travel of the industrial handling robot, in particular a reference travel which is carried out automatically.

10. The tool-presetting and/or tool-measuring system according to claim 8, wherein the control and/or regulation unit is configured to carry out, by means of the coordinate recognition, a collision check on the basis of a determination of relative positionings of tool and/or tool chuck pallets recognized in the camera images and of all positions to be approached by the gripper unit for equipping holding places, in particular holding places of the recognized tool and/or tool chuck pallets which are recognized as being unoccupied.

11. The tool-presetting and/or tool-measuring system according to claim 10, wherein the control and/or regulation unit is configured to determine optimal movement paths, in particular shortest movement paths and/or movement paths provided with a simplest movement sequence, for the gripper unit for approaching at least one unoccupied holding places, and in particular to output them to an actuation of the gripper unit.

12. The tool-presetting and/or tool-measuring system according to claim 1, wherein the control and/or regulation unit is configured to determine, by means of the coordinate recognition, an occupation situation of holding places of the tool and/or tool chuck pallets.

13. The tool-presetting and/or tool-measuring system according to claim 1, further comprising at least one further camera which is at least configured to capture further camera images of the tool-presetting and/or tool-measuring region of the tool-presetting and/or tool-measuring apparatus, of the tool-storage, tool-retrieval or tool-intermediate storage region and/or of at least a part of a movement range of the gripper unit, preferably a complete movement range of the gripper unit, wherein the trained machine-learning algorithm of the control and/or regulation unit is configured to carry out the coordinate recognition on the basis of a combined evaluation of the camera images of the camera and of the further camera images of the further camera.

14. The tool-presetting and/or tool-measuring system according to claim 1, wherein at least one further measuring sensor of the tool-presetting and/or tool-measuring apparatus which is different from the camera, and in particular from the further camera, is configured to be used by the control and/or regulation unit when carrying out the coordinate recognition.

15. The tool-presetting and/or tool-measuring system according to claim 1, wherein at least one further measuring sensor of the tool-presetting and/or tool-measuring apparatus which is different from the camera, and in particular from the further camera, is configured to be used by the control and/or regulation unit for a plausibility check of the data determined in the coordinate recognition, such as, for example, positions, dimensions, etc.

16. The tool-presetting and/or tool-measuring system according to claim 14, wherein the further measuring sensor is a laser triangulation sensor of the tool-presetting and/or tool-measuring apparatus, a tactile probe of the tool-presetting and/or tool-measuring apparatus, a Twip sensor of the tool-presetting and/or tool-measuring apparatus or a transmitted-light camera of the tool-presetting and/or tool-measuring apparatus.

17. The tool-presetting and/or tool-measuring system according to claim 1, wherein at least one further operating parameter of a component of the tool-presetting and/or tool-measuring system which is different from a sensor measured value, for example a power consumption of a gripper unit of the tool-presetting and/or tool-measuring system or of a rotation unit of the tool-presetting and/or tool-measuring apparatus, is configured to be used by the control and/or regulation unit for a plausibility check of the data determined in the coordinate recognition, such as, for example, dimensions of tools, tool chucks, complete tools and/or tool and/or tool chuck pallets.

18. The tool-presetting and/or tool-measuring system according to claim 1, wherein the control and/or regulation unit, in particular the trained machine learning algorithm of the control and/or regulation unit, is configured to recognize, at least on the basis of the camera images, at least a presence of an operator, and preferably to determine location coordinates of the operator.

19. The tool-presetting and/or tool-measuring system according to claim 18, wherein the control and/or regulation unit or a further control unit of the tool-presetting and/or tool-measuring system is configured to adapt a system parameter, in particular a movement speed of at least one component of the tool-presetting and/or tool-measuring system, such as, for example, of a rotation unit of the tool-presetting and/or tool-measuring apparatus, of a clamping mechanism of a tool and/or tool chuck holding unit of the tool-presetting and/or tool-measuring apparatus or of a gripper unit of the tool-presetting and/or tool-measuring system, depending on the recognized presence or absence of the operator, in particular depending on a recognized location coordinate of an operator present.

20. A tool-presetting and/or tool-measuring method, in particular by means of a tool-presetting and/or tool-measuring system according to claim 1, wherein, in at least one method step, a camera, in particular of an optical tool-presetting and/or tool-measuring apparatus, captures camera images of a tool-presetting and/or tool-measuring region of the tool-presetting and/or tool-measuring apparatus and/or of a tool-storage, tool-retrieval or tool-intermediate-storage region and wherein, in at least one further method step, the camera images are at least temporarily stored and evaluated by a control and/or regulation unit, wherein, in at least one further method step, a coordinate recognition is carried out by a trained machine-learning algorithm on the basis of the evaluated camera images, which coordinate recognition comprises a recognition of tools, tool chucks, complete tools and/or tool and/or tool chuck pallets and a determination of the coordinates thereof in a fixed coordinate system.

21. A computer program product and/or computer program computing infrastructure, comprising commands which, when the computer program is executed by a computing unit, cause said computing unit to execute the steps of the tool identification method according to claim 20, which steps comprise the execution of the trained machine-learning algorithm.

22. A control and/or regulation unit for a tool-presetting and/or tool-measuring system according to claim 1, comprising a computer program product according to claim 21.
